(19) United States
(12) Patent Application Publication
(10) Pub. No.: US 2022/0072718 A1
(43) Pub. Date: Mar. 10, 2022

(54) Gripping Device

(71) Applicant: POLY-CLIP SYSTEM GMBH & CO. KG, Hattersheim (DE)

(72) Inventor: Martin BERGMANN, Hösbach (DE)

(21) Appl. No.: 17/416,451

(22) PCT Filed: Dec. 18, 2019
(86) PCT No.: PCT/EP2019/086063

§ 371 Date: Jun. 18, 2021

(30) Foreign Application Priority Data
Dec. 19, 2018 (DE) 10 2018 132 888.5

(51) Int. Cl. B25J 15/06; B25J 11/00; B25J 15/00; B25J 15/02; A22C 17/00; A22C 25/08; A22C 11/00

(52) U.S. Cl. CPC B25J 15/0616; B25J 11/0045; B25J 15/0038; A22C 11/008; B25J 15/0052; A22C 17/0093; A22C 25/08; B25J 15/026

(57) ABSTRACT

The present invention relates to a gripping device for picking up, conveying, and delivering a product, the gripping device including: a base structure which may be attached to a handling device by means of a coupling element, preferably so in a non-destructively detachable manner; at least two gripper members having each at least one bottom surface and at least one top surface, said top surface of the gripper members facing towards the coupling element and said bottom surfaces of the gripper members facing away from the coupling element; at least one drive means for reversibly moving the gripper members between a first position, in which the gripper members may be positioned on opposite sides of the product to be picked up, and a second position, in which the gripper members seize the product to be picked up; and an abutment plate which is at least approximately supported by the top surfaces of the gripper members.

### FIELD OF THE INVENTION

The present invention relates to a gripping device for picking up, conveying, and delivering a product, in particular a gripping device that is attached to a handling device, and is to be used for handling foodstuff.

### BACKGROUND

Within the frame of the present invention, the gripping device, which is attached, for example, to a handling device, serves, on the one hand, for picking up, conveying, and delivering a product, and, on the other, for pressure-compacting said product into a predefined shape. For this purpose, the product is preferably picked up from a product support and is seized by the gripping device. Then, the product is transported, and delivered, to a predefined position by means of the handling device. In addition, the product is specifically pressure-compacted on its circumference by means of the gripping device, preferably so from above and from the sides.

For example, in order to allow a product, such as a strand of meat, to be cut into slices of approximately equal thickness and weight, it is necessary for the meat strand to be first pressure-compacted into a predefined shape in order to facilitate the cutting process within the portioning machine. For this purpose, according to the state of the art, the meat strand is inserted into a form tube or magazine tube and pressure-compacted by means of an abutment plate arranged on one end of the form tube and a displaceable pressure ram. The shape of the meat strand is defined by that of the form tube.

Since long meat strands, in particular, may have considerable weight, the acts of picking up and inserting these meat strands may be very strenuous and burdensome for an operator.

It is an object of the invention to provide a gripping device which may be attached to a handling device and a method of controlling said gripping device, which device and method are capable of relieving the burden of an operator, of compressing the product, preferably from its lateral sides, and of shortening cycle times.

### SUMMARY OF THE INVENTION

This object is accomplished, according to the present invention, by providing a gripping device as well as a method of controlling said gripping device, which are defined by the independent claims 1 and 10. Further developments of the invention are defined in the dependent claims.

An inventive gripping device for picking up, conveying, and delivering a product includes a base structure which may be attached to a handling device by means of a coupling element, preferably so in a non-destructively detachable manner, at least two gripper members having each at least one bottom surface and at least one top surface, said top surfaces of the gripper members facing towards the coupling element and said bottom surfaces of the gripper members facing away from the coupling element, at least one drive means for reversibly moving the gripper members between a first position, in which the gripper members may be positioned on opposite sides of a product to be picked up, and a second position, in which the gripper members seize the product to be picked up, and an abutment plate which is at least approximately supported by the top surfaces of the gripper members.

This gripping device is capable of seizing or gripping a product such as foodstuff in the form of a meat strand, or other foodstuff having similar consistency such as fish or bread, and of conveying it, for example, to a station for further processing. On the one hand, the gripping device alleviates the burden weighing on the operator who, according to the state of the art, has to perform this operation manually. On the other, the process may be accelerated, which leads to higher clock speeds an increased production rate and greater flexibility, since several processing stations may be fed by a single handling device. In addition, the procedure may also contribute to achieve cost savings.

The abutment plate may be realised, on at least a side facing the gripper members, in particular the bottom side, in an essentially flat and/or planar manner. The abutment plate may serve for preventing the product to be picked up by the gripper members from slipping away laterally upwards while the product is being seized by the gripper members. The abutment plate may further be configured to be supported by the top surfaces of the gripper members both in the first and in the second position. The abutment plate may be dimensioned in such a manner and/or one dimension of the abutment plate may be adapted to a distance of the gripper members with respect to each other or to an movement amplitude of said gripper members, such that the abutment plate is supported by the top surfaces of the gripper members both in the first and in the second position.

In an exemplary embodiment, a motor such as a servomotor, a stepper motor, an asynchronous motor and/or a direct current motor may be coupled to the gripper members in order to control their movements, to adjust a compressive force applicable to the product that is to be pressure-compacted, and/or to convey the product that has been picked up and optionally pressure-compacted by the grippers to a desired station for further processing such as a meat portioning machine. The motor may be configured for providing a compressive force of at least 100 N, at least 500 N, at least 1000 N, at least 1500 N, at least 2000 N, at least 2500 N or at least 3000 N.

The motor permits to flexibly react to different product dimensions, thus enabling the gripping device according to the invention to seize and handle products of different dimensions and/or consistencies. The utilisation of the motor has proven particularly advantageous with respect to the handling of raw products which need to be seized and further processed in a frozen condition or which have at least started to freeze. On the one hand, the products to be handled have a high weight and on the other, a considerable force is needed for pressure-compacting the frozen product, or the product that has started to freeze, into a desired shape, which force may be readily provided and/or adjusted by means of the motor. Basically, raw products in a non-frozen condition, or products that have not yet started to freeze, may also undergo further processing.

According to a further exemplary embodiment, the product is seized and subsequently compressed by the following steps: lowering the support plate onto the product to be picked up and compressed in a translatory, vertical manner; moving the gripper members toward each other in a translatory, horizontal manner so as to form a closed reception space between the lateral gripper members, the abutment plate arranged vertically at the top and, optionally, the product support arranged vertically at the bottom such as a feeding appliance which may be realised, for example, in the form of a conveyor belt or transport belt; exerting a desired pressure or a desired compressive force on the picked-up product by means of the gripper members, the application of the retention force being realised and/or adjusted by means of a motor such as a servomotor. During this process, the abutment plate may remain stationary and may be operable to prevent the product from slipping away in an upward direction.

In an exemplary embodiment, the support plate is rested on the top surfaces of the gripper members in each of the operating positions of the gripper members. In other words, a horizontal translatory movement amplitude of the gripper members is adjusted in such a manner that the abutment plate will always rest on the top surfaces of the gripper members.

In some embodiments, the gripper members of the gripping device are provided with inwardly curved gripping surfaces which are capable of reaching at least partially under the product to be picked up. This shaping of the gripper members may safely prevent the product from slipping down. In addition, the gripping surfaces may be used to contribute to the shaping of the product.

The gripper members may, for example, have a cup-like shape and/or may be concavely curved. Furthermore, the top surfaces and the bottom surfaces of the gripper members may be integrally formed from a single piece of material. The gripper members may be configured and/or dimensioned in such a manner that they reach only partially under the picked-up product, thus ensuring continuous contact between the product and the product support. In total, the gripper members may, for example, reach under less than 90%, less than 80%, less than 70%, less than 60% or less than 50% of the product.

In some embodiments, at least one of the gripper members is translatorily and/or rotatorily movable with respect to the base structure. Due to the translatorily and/or rotatorily movable gripper members, it is possible to pick up products at points that are not easily accessible since the width of the gripping device can be reduced. This may be realised, for example, by means of rotatorily supported gripper members which may be reversibly opened and closed in a scissor-like manner, necessitating a small gripper opening width in order to seize the product.

In some embodiments, the gripper members are fastened to the base structure by fastening means that may be detached without tools. This makes it possible for the gripper members to be quickly exchanged, allowing to adapt the gripper members to any specific type of product and to the desired shaping of the latter.

In some embodiments, at least one suction element is arranged on the abutment plate which lifts the product to be picked up at least partially during a suction process. During this process, the suction element serves for sucking the product away from a product support surface which may be a conveyor belt conveying the product to the gripping device. Thus, the gripper members need not be applied onto the product support in order to precisely seize the product.

In some embodiments, the suction element is embedded or integrated into the abutment plate in such a manner that it forms an at least approximately even surface with the abutment plate during the suction process. This specific arrangement of the suction element ensures that the product will not be undesirably deformed by the suction element.

In some embodiments, each of the gripper members is guided by at least two guide rods. This enhances the stability of the gripper members and prevents a rotatory movement about one of the guide rods and/or reduces the forces required to prevent such rotation.

In some embodiments, the gripper members of the gripping device are capable of pressure-compacting the product into a predefined shape. Pressure-compacting the product is often required in order to be able to insert it into an element referred to as a shaped tube or magazine tube. Since the processes of conveying and pressure-compacting may occur in one processing step, this permits to save time and additional components on the station for further processing. The product is pressure-compacted, for example, to a predefined cross-section, such that it may subsequently be delivered to the magazine tube of the portioning machine. Therefore, said predefined cross-section will preferably be smaller than the cross-section of the form tube or magazine tube of the portioning machine. The handling device may enable the gripping device to pivot the foodstuff product in such a manner during the transport from the transporting device to the magazine tube that it may be brought into a suitable position in which the foodstuff product may be delivered to the magazine tube. For example, as the foodstuff product is transported from the transporting device to the magazine tube, it may be rotated with respect to the magazine tube in such a manner that it is positioned vertically above the magazine tube and may be delivered to, or ejected into, the magazine tube.

In some embodiments the abutment plate has a detection means arranged thereon which is capable of detecting the presence of the product. Product detection serves for detecting when the product is located between the gripper members, which enables the product to be seized in a precise and time-controlled manner.

According to an inventive method of controlling a handling device having a gripping device, preferably a gripping device of the type discussed further above, said method includes the steps of: detecting the product to be picked up from a product support, positioning the gripper members of the gripping device in a first position in which the gripper members are positioned on opposite sides of the product to be picked up, seizing the product to be picked up by reversibly moving at least one of the gripper members in the direction of the product until it has reached a second position, compressing the product, with the product capable of being compressed into a predefined shape by means of the gripper members and the abutment plate and, optionally, the product support, and moving the gripping device and product to a predefined position.

According to another method of controlling a handling device including a gripping device the product placed on the product support is pressure-compacted into a predefined shape by means of the gripper members, the abutment plate, and the product support.

According to a further method of controlling a handling device including a gripping device, the product is pressure-compacted into a predefined shape by means of the gripper members and the abutment plate while in the process of being conveyed.

According to a further embodiment, a lifter may be arranged below a product support and/or a transport belt, said lifter being capable of lifting the product to be picked up and the product support and/or the transport belt. The lifting of the product support and/or the transport belt serves for preventing the latter from being damaged or inadvertently gripped when the product is being seized by the gripping device. The lifter thus increases the service lifetime of the product support and/or the transport belt since the gripping device has essentially no contact with the latter. Such a configuration may be utilised independently from the gripping device described above.

### DESCRIPTION OF THE DRAWINGS

FIG. 1 shows a perspective view of a gripping device which is attached to a handling device, according to an embodiment of the present invention,

FIG. 2 shows a perspective view of the gripping device shown in FIG. 1,

FIG. 3 shows a top view of the gripping device shown in FIG. 1,

FIG. 4 shows a sectional view, taken along the line V-V in FIG. 3, of the gripping device shown in FIG. 1,

FIG. 5 shows a front view of the gripping device shown in FIG. 1, in an opened condition,

FIG. 6 shows a front view of the gripping device shown in FIG. 1, in a closed condition, and

FIG. 7 shows a front view of a gripping device in an opened condition, according to a further embodiment of the present invention.

### DETAILED DESCRIPTION

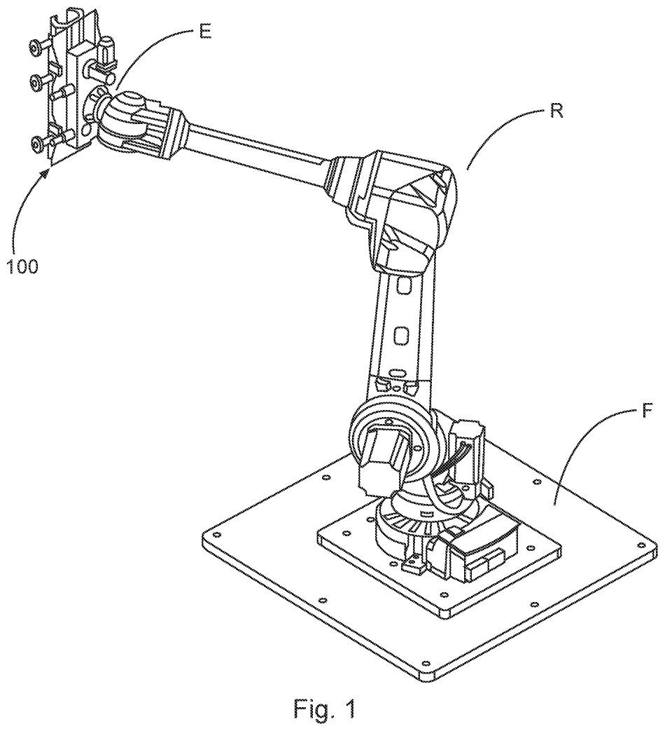

FIG. 1 shows a perspective overall view of a handling device R which is an articulated robot or a six-axis robot. A robot is a manipulator which, in turn, may be defined as a universal, programmable machine for the handling, assembling or processing of workpieces or the like. However, the handling device R might be any other device that is capable of picking up, conveying, and delivering a product. A portal robot, a Scara robot, a parallel robot or a crane, for example, might be conceived a an alternative.

The robot R is supported by one or several foundation plates F, with the robot R and the foundation plates F being anchored in the ground, preferably using fastening means such as screws. The foundation plates F transfer the forces created during the operation of the robot R over a large area into the ground. The term ground is to be understood as suitable foundations capable of absorbing the forces of the robot R, of attenuating them and of transmitting them over a large area into the soil.

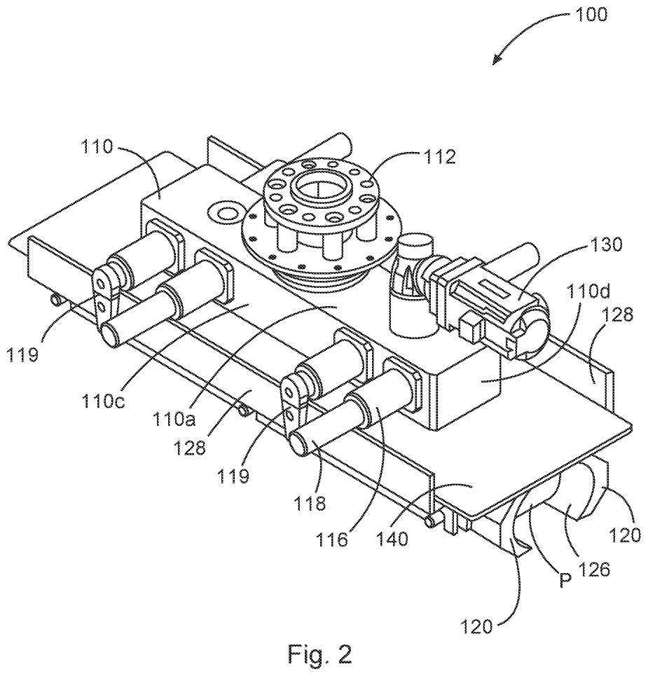

At the free end of the robot arm, that is not otherwise specified, an end flange E is provided which serves for detachably fastening an inventive gripping device 100 as described hereinafter in connection with FIGS. 2 to 7.

Control of the robot R and the gripping device 100 is preferably effected via a separate control unit, not shown, which is connected to the robot R. In addition, the gripping device 100, as well as the robot R, are directly activated by the control located within the control unit.

Preferably, the gripping device 100, the robot R, and the control are all powered by at least one external power supply.

The articulated robot R is capable of performing both translatory and rotatory movements and is thus freely movable in space. In addition, the gripping device 100, which is fastened to the robot R, may be activated independently of said robot R, which makes it possible for the robot R and the gripping device 100 to be activated simultaneously. This is to say that the gripping device 100 may be opened and closed while the robot R is being moved, thus enabling the product P to be pressure-compacted into a predefined shape.

FIGS. 2 to 4 show different views of the gripping device 100 according to the invention. The gripping device 100 is essentially provided with a cuboidal base structure 110, two gripper members 120, drive means 130 for translatorily moving the gripper members 120, and an abutment plate 140.

FIG. 2 shows a perspective view of the gripping device 100. The gripping device 100 consists of an essentially cuboidal, elongated base structure 110 which is preferably made of stainless steel or some other material suitable for contact with foodstuffs and is realised either in the form of solid material or of some material or sheet metal bent into a cuboidal shape, depending on the degree of strain to which the respective component is exposed. Furthermore, the base structure 110 may have a coating that protects the material and/or conveys suitability for contact with foodstuffs to the base structure 110.

The cuboidal base structure 110 has a surface 110a facing towards the end flange E of the robot R, a parallel, opposing surface 110b facing away from the end flange E of the robot R, two opposing lateral surfaces 110c, a front surface and a rear surface 110d, with the two lateral surfaces 110c and the front surface and the rear surface 110d interconnecting the two surfaces 110a and 110b. The front surface 110d and the corresponding opposite rear surface 110d are rectangular, their lengths and widths being at least approximately geometrically similar to each other. In contrast, the two lateral surfaces 110c, the surface 110a facing towards the end flange E, and the surface 110b facing away from the end flange E, of the base structure 110 have a length that is several times longer than the length or width of the front surface or the rear surface 110d of said base structure 110. The length of the surfaces 110a, 110b, 110c of the base structure 110 which extend vertically from the front surface or rear surface 110d depends essentially on the length of the product P to be picked up.

On its side surface facing towards the robot R when it is mounted to said robot R, the base structure 110 is attached to the end flange E of the robot R by means of a coupling element 112 that is fastened to the base structure 110 The coupling element 112 is fastened at the centre of the surface 110a of the base structure 110 which faces toward the end flange E of the robot, said coupling element 112 allowing for removable attachment to the robot R. The coupling element 112 is firmly connected to the base structure 110 and on its free end has an essentially disc-shaped connecting portion which is not otherwise specified and may be detachably connected to the end flange E of the robot R, for example by means of screws.

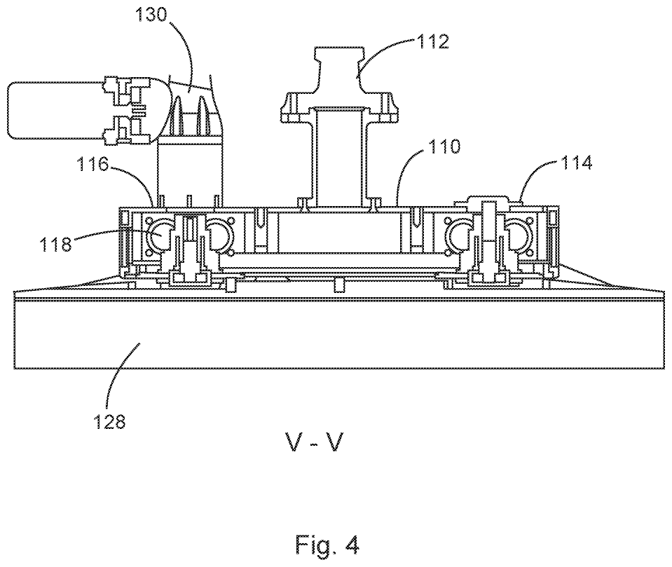

Four essentially circular or round openings 114 are recessed or incorporated in the lateral surfaces 110c of the base structure 110. As shown in the sectional view of FIG. 4, the openings 114 are arranged centrally with respect to the lateral surfaces 110c of the base structure 110 when considered in a longitudinal direction.

In addition, cylinder extension sockets 116 or guide sleeves are preferably arranged laterally on both sides of the respective end portions of the openings 114, which are disposed in such a manner that they are oriented vertically with respect to the lateral surfaces 110c of the base structure 110 and thus extend the respective axial lengths of the base structure 110. The cylinder extension sockets 116 are oriented in such a manner that they are parallel to the front surface and the rear surface 110d and to the surface 110a facing towards the end flange E and to the surface 110b facing away from the end flange E.

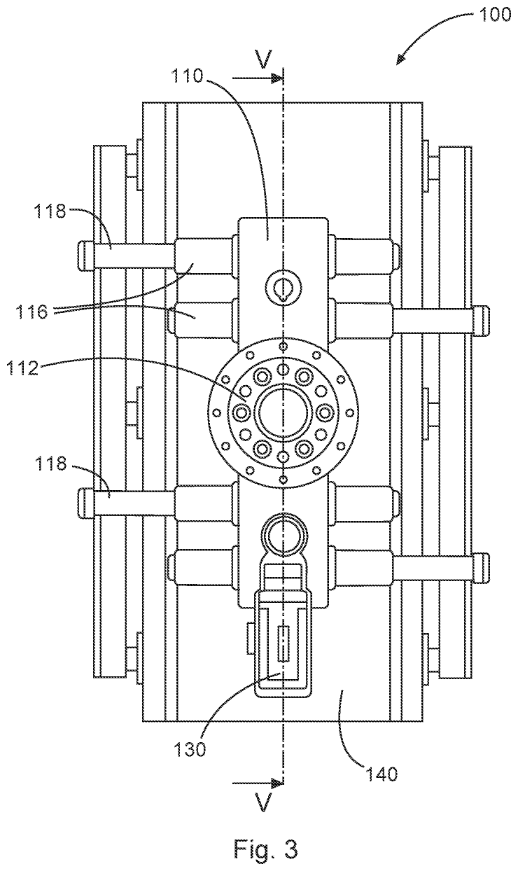

FIG. 3 shows a top view of the gripping device 100. The cylinder extension sockets 116 are arranged in such a manner that four cylinder extension sockets 116 are present on each end portion of the lateral surfaces 110c of the base structure 110. Alternately, two cylinder extension sockets 116 are associated with a respective one of the gripper members 120 and the adjacent cylinder extension sockets 116 are associated with the other gripper member 120.

As may be seen, in particular, from FIG. 4, the cylinder extension sockets 116 are incorporated into the base structure 110 in a manner so as to extend essentially parallel to the surface 110a facing towards the end flange E and to the surface 110b facing away from the end flange E.

Two respective ones of the cylinder extension sockets 116 accommodate a corresponding, cylindrical piston 118 or a guide rod 118 which is respectively movable in axially reversible directions and which advantageously has an axial length that is longer than the axial length between two opposing cylinder extension sockets 116. In the present embodiment, two respective guide rods 118 or four cylinder extension sockets 116 are associated with one gripper member 120.

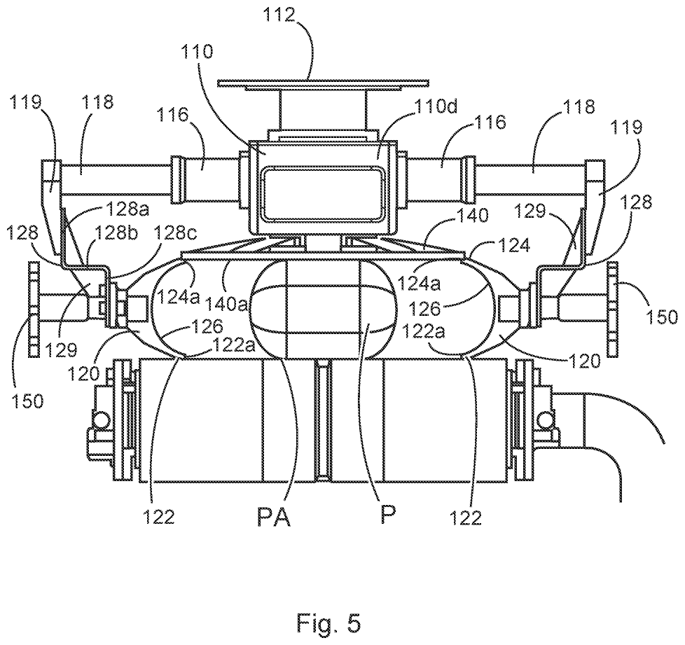

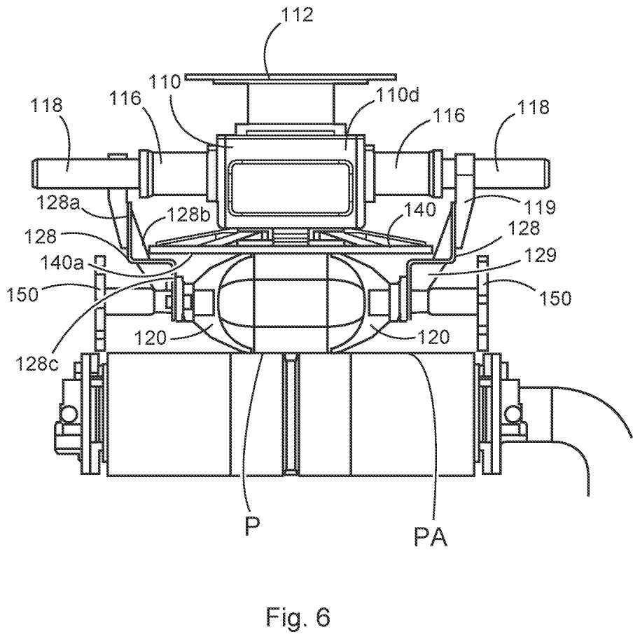

The guide rods 118 serve for reversibly extending and retracting the gripper members 120 of the gripping device 100, as shown in FIGS. 5 and 6 and discussed in greater detail hereinafter. For this purpose, the guide rods 118 are moved to and fro within the cylinder extension sockets 116 using a drive means 130 which will equally be discussed below in greater detail.

The four guide rods 118 are driven by means of a servomotor via a toothing, preferably in the form of a gear rack or a spindle drive. The two guide rods 118 arranged closest to the front surface 110d of the base structure 110 are driven by a drive means 130 and the two guide rods 118 arranged closest to the rear surface 110d of the base structure 110 which are connected to the drive means 130 via a belt drive are equally driven, which causes the guide rods 118 to perform a synchronous movement.

As may be seen from FIGS. 5 and 6, the cylinder extension sockets 116 serve, on the one hand, for guiding the guide rods 118 and, on the other, enable a greater gripper opening width in order to make it possible to seize greater or smaller products P, as the case may be. At the same time, the base structure 110 may be kept small in its spatial dimensions. Adapting the maximum gripper opening width of the gripping device 100 to the width of the product P on the one hand leads to a design of the gripping device 100 that is as compact as possible and, on the other, permits shorter cycle times to be achieved since the gripper members 120 may perform shorter travelling distances when the gripping device 100 is opened or closed.

If the gripper opening width of the gripping device 100 is to be increased, this will necessitate the use of longer guide rod 118. When the gripper members 120 of the gripping device 100 are in an opened position, the extended guide rod 118 will lead to greater lever forces at the exit point of the guide rod 118 (here: at the lateral surfaces 110c of the base structure 110). These may be reduced or attenuated by using cylinder extension sockets 116 which serve to shift the point at which the lever force is applied.

In addition, on the free ends of two respective guide rods 118 belonging to a gripper member 120, a lateral sheet 128 is attached essentially in a vertical manner with respect to the guide rods 118 by means of two connecting elements 119, with the respective free ends of the lateral sheets 128 facing away from the end flange E of the robot R.

The connecting elements 119 have a cylindrical indentation on one end thereof which may be slid onto the guide rods 118 or may, for example, be pressure-bonded therewith or screwed thereon. In order to connect the guide rod 118 to the connecting element 119, other means such as bonding, welding or soldering may also be employed.

The connecting element 119 consists of, for example, stainless steel or of some other type of material suitable for contact with foodstuffs. Furthermore, the connecting element 119 may have a coating that protects the material and/or conveys suitability for contact with foodstuffs to the connecting element 119.

The connecting element 119 serves for transmitting the linear movement of the guide rods 118 to the lateral sheets 128 that are attached to the free ends of the connecting elements 119. The lateral sheets 128 are preferably welded, soldered, or screwed to the connecting elements 119.

The lateral sheets 128 are formed by a folded sheet bent a number of times, with a first portion 128a, which is firmly connected to the connecting element 119, extending essentially vertically, by reference to FIG. 5, a second portion 128b extending essentially horizontally, and a third portion 128c extending essentially vertically, thus leading to a staircase-like configuration for a lateral sheet 128. The first and third portions 128a, 128c have a greater width than the second portion 128b. A first bending line is situated at approximately one third of the width of the lateral sheet 128 and the second bending line is situated at approximately two thirds of the width of the lateral sheet 128.

In order to ensure sufficient stiffness to the lateral sheet 128 when exposed to a load, the staircase-like lateral sheets 128 are reinforced by cross braces or by laterally extending metal sheets, depending on the type of strain or load experienced. The cross braces 129 or the laterally extending metal sheets are arranged in such a manner as to reinforce the essentially vertically bent portions of the lateral sheets 128.

The two lateral sheets 128 are arranged essentially opposite each other, with the base structure 110 being located partially between the lateral sheets 128. On each of the lateral sheets 128 a respective gripper member 120 is attached with its free end as considered in a longitudinal direction and which is preferably fastened by at least one fastening means 150 that may be detached without tools, such as a locking device or a manually actuatable screw fixing. It goes without saying that it is also possible to use fastening means that may not be detached without tools such as screwing or welding, in order to connect the lateral sheet 128 to the gripper member 120.

In the present embodiment, a plurality of fastening means 150 or screw fixings are disposed in series by means of which the gripper members 120 are fastened at their ends to the lateral sheets 128 which face away from the end flange E of the robot R. Obviously, it is also possible to provide only one fastening means 150 per gripper member 120.

The gripping surfaces 126 of the gripper members 120 have a C-shaped configuration extending essentially in a longitudinal direction, said gripper members 120 being arranged in such a manner that their C-shaped or concave gripping surfaces 126 face towards each other. The gripping surfaces 126 may have smooth as well as undulated or corrugated surface structures which may be provided with longitudinally or transversally extending grooves.

The gripper members 120 consist of, for example, stainless steel, plastic material or of some other type of material suitable for contact with foodstuffs. Furthermore, the gripper members 120 may have a coating that protects the material and/or conveys suitability for contact with foodstuffs to the gripper members 120.

The axial length of the gripper members 120 preferably depends on the length of the product P to be seized. In the present embodiment, the length of the gripper members 120 is slightly greater than that of the product P to be seized, as shown, for example, in FIG. 2.

For enabling a reversibly translatory movement of the gripper members 120 in the direction of the respective opposite gripper member 120, each gripper member 120 has at least one guide rod 118, preferably two guide rods 118, associated therewith which may be actuated pneumatically, servopneumatically, hydraulically or by means of an electric drive mechanism.

Strictly speaking, and as mentioned above, there may be provided only one guide rod 118 and/or only one drive mechanism 130 for moving the gripper members 120. However, due to the length of the gripper members 120, at least four cylinder extension sockets 116 and two guide rods 118 are preferably provided per gripper member 120 since these may serve as a guide to prevent any undesirable torsional movement of the gripper members 120.

By utilising drive means 130 to drive the guide rods 118 within the cylinder extension sockets 116, the gripper members 120 may be reversibly and translatorily moved towards each other from a first, open position in which the gripper members 120 may be positioned on opposite sides of the product P to be picked up and in which preferably they are spaced apart from each other by the greatest possible distance (FIG. 5) to a second, closed position in which the gripper members 120 grip or seize the product P to be picked up (FIG. 6). FIGS. 5 and 6 show the gripping device 100 in an opened and closed position, respectively. The opened and closed positions may be variably adjusted by the drive means 130 or by the servomotors 130. In principle, it is possible to use a stepper motor, an asynchronous motor or a direct current motor instead of, or in addition to, the servomotor.

The motor, which may be configured, for example, as a servomotor 130, may be coupled to the gripper members 120 in order to control their movements, to adjust a compressive force applicable to the product that is to be pressure-compacted, and/or to convey the product that has been picked up and optionally pressure-compacted by the gripper members 120 to a desired station for further processing such as a meat portioning machine. The servomotor 130 may be configured for providing a compressive force of at least 100 N, at least 500 N, at least 1000 N, at least 1500 N, at least 2000 N, at least 2500 N or at least 3000 N.

The servomotor 130 permits to flexibly react to different product dimensions, thus enabling the gripping device according to the invention to seize and handle products of different dimensions and/or consistencies. The utilisation of the servomotor 130 has proven particularly advantageous with respect to the handling of raw products which need to be seized and further processed in a frozen condition or which have at least started to freeze. On the one hand, the products to be handled have a high weight and on the other, a considerable force is needed for pressure-compacting the frozen product, or the product that has started to freeze, into a desired shape, which force may be readily provided and/or adjusted by means of the motor. Obviously, raw products in a non-frozen condition, or products that have not yet started to freeze, may also undergo further processing.

The guide rods 118 which move within the cylinder extension socket 116 transmit their linear movement to the connecting elements 119, to the lateral sheets 128 and, consequently, to the gripper members 120 attached thereon. Advantageously, the gripper members 120 act in parallel, i. e. the gripper members 120 move towards each other and away from each other in synchronism as they open and close. It goes without saying that the gripper members 120 may also be actuated sequentially, or only one gripper member 120 is reversibly moved towards the other gripper member 120 which, in this case, is preferably stationary.

The gripper members 120 have respectively a bottom surface 122 and a top surface 124, with the top surfaces 124 of the gripper members 120 facing towards the base structure 110 of the gripping device 100 and the bottom surfaces 122 of the gripper members 120 facing away from the base structure 110 of the gripping device 100.

The gripper members 120 may, for example, have a cup-like shape and/or may be concavely curved. Furthermore, the top surfaces 124 and the bottom surfaces 122 of the gripper members 120 may be integrally formed from a single piece of material. According to the exemplary embodiments depicted in the figures, the gripper members 120 reach only partially under the picked-up product, thus ensuring continuous contact between the product and the product support PA. In a further exemplary embodiment, the gripper members 120 have an L-shaped structure when considered in cross-section. The top surfaces 124 may extend in a rectilinear manner. Furthermore, the bottom surfaces 122 may equally be rectilinear in certain sections thereof, with a side adjoining the respective top surface 124 extending parallel to the lateral surface areas and/or a bottom-facing side to be applied to the product support PA being oriented essentially normally with respect to the other side. The dimensioning of the bottom-facing side may be greater than the dimensioning of the other side and, possibly, that of the top surface 124.

The abutment plate 140 is realised, on at least a side facing the gripper members 120, in particular the bottom side, in an essentially flat and/or planar manner (cf. FIG. 5 and FIG. 6). The abutment plate 140 may serve for preventing the product to be picked up by the gripper members 120 from slipping away laterally upwards while the product is being seized by the gripper members 120. As may be seen from FIG. 5 and FIG. 6, when viewed together, the abutment plate 140 is configured to be supported by the top surfaces 124 of the gripper members both in the opened condition of the gripper members 120 (FIG. 5) and in the closed position (FIG. 6). The abutment plate 140 is dimensioned in such a manner and/or one dimension of the abutment plate 140 is adapted to a maximum horizontal distance of the gripper members 120 with respect to each other or to an movement amplitude of said gripper members 120, such that the abutment plate 140 is supported by the top surfaces 124 of the gripper members 120 both in the first and in the second position.

The at least one drive means 130 is arranged on the side of the base structure 110 facing towards the end flange E at the centre between two adjacent guide rods 118 which are located between respective coupling elements 112, as shown in FIG. 3. The drive means 130 is guided to the guide rods 118 that need to be driven via an opening provided in the surface of the base structure 110 that faces towards the end flange E.

The guide rods 118 are preferably driven by means of a servomotor and gear racks. Alternatively, the guide rod 118 may be realised itself as a gear rack. Furthermore, the guide rods 118 may optionally be driven by a threaded spindle, a ball screw or a metric threaded spindle instead of a gear rack. In addition, a crank gear may be used instead of the gear rack for driving the gripper members 120.

In the present embodiment, one drive mechanism 130 is sufficient in order to move the gripper members 120, with two guide rods 118 being driven by the drive mechanism 130, while the other two guide rods 118 are connected to the driven guide rods 118 via a toothed-belt drive and are therefore equally driven. In some embodiments, however, two drive means 130 may be provided, with each drive means 130 driving two guide rod 118, respectively. As may be seen from FIG. 3, an opening for accommodating said second drive means 130 has been provided in the surface 110a of the base structure 110 facing towards the end flange E of the robot R.

Moreover, in a further embodiment, a coupling element (not shown) may be provided which connects two guide rods 118 which belong to one gripper member 120, respectively. In this manner, two guide rods 118 belonging together may be activated by one drive means 130.

The essentially rectangular abutment plate 140 is attached to the surface 110b of the base structure 110 facing away from the end flange E. The abutment plate 140 has a width corresponding at least to the maximum opening width of the gripper members 120 and a length preferably corresponding to the axial length of the gripper members 120. The abutment plate 140 is arranged in such a manner that it is supported in an at least approximately planar manner by the top surfaces 124 of the gripper members 120.

The gripper members 120 as well as the abutment plate 140 are manufactures of POM Food, stainless steel or plastic material, with other materials suitable for contact with foodstuffs being equally possible, which, in addition, are capable of resisting the loads encountered during the gripping process. Furthermore, the gripper members 120 and the abutment plate 140 may have a coating that protects the material and/or conveys suitability for contact with foodstuffs to the base structure 110.

The edges 122a, 124a and/or the top surface and the bottom surface 122, 124 of the gripper members 120 are advantageously rounded in order to reduce friction between a product support PA and the abutment plate 140. In addition, the gripper members 120 may be coated either all over or partially on their edges 122a, 124a and on the top surface and bottom surface 122, 124, with the coating acting to reduce friction.

Advantageously, the lateral sheets 128 on which the gripper members 120 are attached are bent in such a manner that on the one hand, they do not collide with the abutment plate 140 and, on the other, allow the product P to be safely seized.

As explained further above, the lateral sheets 128 have a staircase-shaped configuration, with the lateral sheets 128 being cost-efficient and allowing easy fabrication, for example by using a bending machine.

In addition, the drive means 130 of the guide rods 118 is capable of pressure-compacting the product P which has been picked up by the gripper members 120. The pressure-compacting is carried out essentially from the sides, with the product P being compressed into a predefined shape. In addition, the term pressure-compacting is to be understood in such a manner that the product P is compressed more than what is required to ensure a suitable retention force. The product P is compressed into a predefined shape such that it may subsequently be inserted into an essentially horizontally extending chute or into a form tube or magazine tube.

On the one hand, the product P may be pressure-compacted while being conveyed by means of the handling device R. The abutment plate 140 serves for preventing the product P from slipping away laterally in an upward direction during the process of pressure-compacting.

On the other hand, the product P may be pressure-compacted on the product support PA. The product support PA is, for example, a conveying device such as a conveyor belt or another kind of transporting device. In addition, the product support PA advantageously ensures that the product P that is to be pressure-compacted cannot slip away laterally in a downward direction. The process of pressure-compacting may be carried out either directly upon gripping of the product P or during the movement of the handling device R.

In a further embodiment, the gripper members 120 are translatorily and/or rotatorily movable. For example, the connecting elements 119 which are arranged between the guide rods 118 and the lateral sheets 128 may be possible pivot points for the rotatory movement of a gripper member 120, thus enabling both translatory and rotatory movement of the gripper members 120. A purely rotatorily movable gripping device 100 may, for example, be realised by a scissor-like design of the gripper members 120.

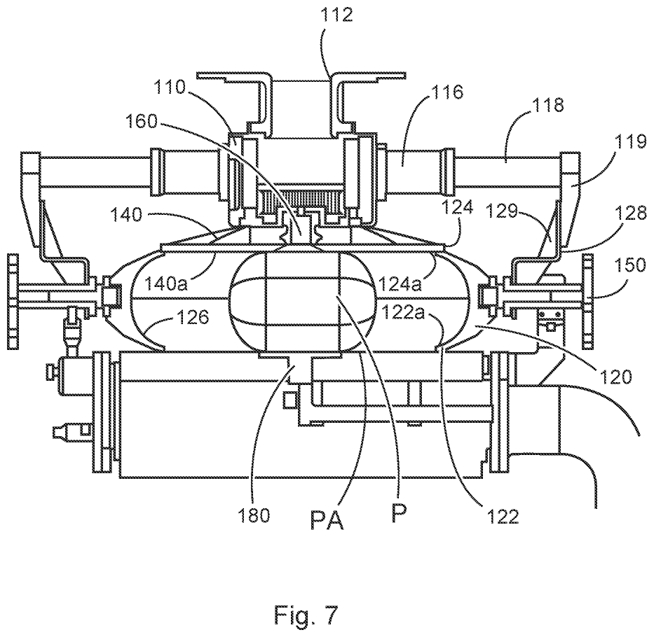

FIG. 7 shows a further embodiment of a gripping device 100 of the present invention in which at least one suction element 160 is arranged on the surface 140a of the abutment plate 140 which faces away from the end flange E of the robot R. Preferably, the at least one suction element 160 is arranged centrally or laterally on the abutment plate 140 or recessed therein. Depending on the length of the product P, several suction elements 160 may be required which are arranged centrally in a row along a longitudinal direction on the abutment plate 140.

The suction elements 160 are configured to be capable of at least partially lifting the product P to be picked up from its support surface PA which may be, for example, a conveyor belt. The suction elements 160 are preferably recessed into the abutment plate 140 in such a manner as to form an at least approximately even surface with the surface 140a of the abutment plate 140 which faces away from the end flange E of the robot R during the suction process.

In addition, FIG. 7 shows an elongate lifter 180 which is arranged below the product support PA. In the following, the lifter 180 may be understood as a system, with the lifter 180 capable of being employed or activated independently of the presence of the suction element 160 and the robot R.

Preferably, the lifter 180 has a T-shaped configuration when considered in a longitudinal direction, with the lifter 180 preferably having approximately the length of the product P to be picked up.

The elongate lifter 180 is arranged below the product support PA, which is preferably a transport belt, in such a manner that it is located at least temporarily and essentially in its entirety below the product P.

The lifter 180 is capable of lifting the product P and product support PA, which serves for making it easier for the gripper members 120 to be slid under the product P and thus to reach under the latter. In addition, the product support PA will not be damaged in the course of the gripping operation since the gripper members 120 are not supported by the product support PA. The lifter 180 may, for example, be activated pneumatically, electrically, or hydraulically.

Furthermore, the lifter 180 may be activated independently of the robot R and/or may be triggered by means of a trigger mechanism such as a light barrier. The trigger mechanism is positioned such that it is triggered by the product P at the point at which the product P is to be seized or shortly afterwards.

Optionally, at least one detection means 170 may be additionally arranged on the abutment plate 140 which detects whether the product P is applied on the abutment plate 140 and/or whether the suction element 160 has sucked the product P or whether the lifter 180 has lifted the product P. The detection means 170 may, for example, be a pressure switch or a sensor (not shown) which is at least partially recessed into the abutment plate 140.

In the following, a method of controlling a handling device R including a gripping device 100 will be described. First, the presence of a product P to be picked up on a product support PA is detected, which detection is performed, for example, by a detection means such as a light barrier. The detection means transmit a signal to the robot R which subsequently positions the opened gripper members 120 of the gripping device 100 in a first position in which the gripper members 120 are positioned on opposite sides of the product P to be picked up. As soon as the first position is reached, the robot R uses the gripping device and seizes the product P to be picked up in that at least one of the gripper members 120 reversibly moves in the direction of the product P until a second position is reached in which the product P has been seized by the gripping device 100. Subsequently, the product P is pressure-compacted or compressed or compressed using a predefined force so as to assume a predefined shape, which is carried out by means of the gripper members 120 and the abutment plate 140 and, optionally, the product support PA. Subsequently, the robot R, together with the gripping device 100 and the picked-up product P, travels to a predefined position in which the product P is delivered.

On the one hand, the product P may be pressure-compacted into a predefined shape by means of the gripper members 120, the abutment plate 140, and the product support PA directly while placed on said product support PA. On the other, the product P may be pressure-compacted into a predefined shape by means of the gripper members 120 and the abutment plate 140 while in the process of being conveyed, which makes it possible to additionally reduce the cycle time, since the conveying operation and the pressure-compacting operation are performed simultaneously.

### REFERENCE SIGNS

R handling device
E end flange
F foundation plate
P product
PA product support
100 gripping device
110 base structure
110a a surface of the base structure facing towards the end flange of the robot
110b a surface of the base structure facing away from the end flange of the robot
110c lateral surfaces of the base structure
110d front and rear surfaces of the base structure
112 coupling element
114 opening
116 cylinder extension socket
118 guide rod
119 connecting element
120 gripper member
122 bottom surface
122a edge
124 top surface
124a edge
126 gripping surfaces
128 lateral sheet
128a first portion of the lateral sheet
128b second portion of the lateral sheet
128c third portion of the lateral sheet
129 cross braces
130 drive means
140 abutment plate
140a side of the abutment plate facing away from the end flange of the robot
150 fastening means
160 suction element
170 detection means
180 lifter

1. A gripping device for picking up, conveying, and delivering a product, said gripping device including:
a base structure which may be attached to a handling device by means of a coupling element, preferably so in a non-destructively detachable manner;
at least two gripper members having each at least one bottom surface and at least one top surface,
wherein the top surfaces of the gripper members face towards the coupling elements and the bottom surfaces of the gripper members face away from the coupling elements;
at least one drive means in order to reversibly move the gripper members between a first position, in which the gripper members may be positioned on opposite sides of the product to be picked up, and a second position, in which the gripper members seize the product to be picked up; and
an abutment plate which is supported at least approximately by the top surfaces of the gripper members.

2. The gripping device as claimed in claim 1,
wherein the gripper members of the gripping device are provided with inwardly curved gripping surfaces which are capable of reaching at least partially under the product to be picked up.

3. The gripping device as claimed in claim 1,
wherein at least one of the gripper members is translatorily and/or rotatorily movable with respect to the base structure.

4. The gripping device as claimed in claim 1,
wherein the gripper members are fastened to the gripping device by fastening means that may be detached without tools.

5. The gripping device as claimed in claim 1,
wherein at least one suction element is arranged on the abutment plate which lifts the product to be picked up at least partially during a suction process.

6. The gripping device as claimed in claim 5,
wherein the suction element is recessed into the abutment plate in such a manner as to form an at least approximately even surface with said abutment plate during the suction process.

7. The gripping device as claimed in claim 1,
wherein each of the gripper members is guided by at least two guide rods.

8. The gripping device as claimed in claim 1,
wherein the gripper members of the gripping device are capable of pressure-compacting the product into a predefined shape.

9. The gripping device as claimed in claim 1,
wherein the abutment plate has a detection means arranged thereon which is capable of detecting the presence of the product.

10. A method of controlling a handling device including the gripping device as claimed in claim 1, including the steps of:
detecting the presence of the product to be picked up on a product support;
positioning the gripper members of the gripping device in a first position in which the gripper members are positioned on opposite sides of the product to be picked up;
seizing the product to be picked up in that at least one of the gripper members reversibly moves in the direction of the product until a second position is reached;
compressing the product,
wherein the product is pressure-compacted into a predefined shape by means of the gripper members and an abutment plate and, optionally, the product support, and
moving the gripping device together with the product to a predefined position.

11. The method of controlling a handling device including the gripping device as claimed in claim 10,
wherein the product, placed on the product support is pressure-compacted into a predefined shape by means of the gripper members, the abutment plate, and the product support.

12. The method of controlling a handling device including the gripping device as claimed in claim 10,
wherein the product is pressure-compacted into a predefined shape by means of the gripper members and the abutment plate during the process of being conveyed.
